(19) United States
(12) Patent Application Publication
(10) Pub. No.: US 2006/0080572 A1
(43) Pub. Date: Apr. 13, 2006

(54) Set associative repair cache systems and methods

(76) Inventor: John Y. Fong, Allen, TX (US)

Correspondence Address: TEXAS INSTRUMENTS INCORPORATED, P O BOX 655474, M/S 3999, DALLAS, TX, 75265, US

(21) Appl. No.: 11/231,001

(22) Filed: Sep. 20, 2005

Related U.S. Application Data
(60) Provisional application No. 60/614,643, filed on Sep. 30, 2004.

(51) Int. Cl. G06F 11/00

(52) U.S. Cl. 714/8

(57) ABSTRACT

The present invention facilitates scaling of memory devices and operation thereof by employing a set associative repair cache system to correct or repair identified faulty memory cells. A repair cache region router 602 compares a repair region portion of a memory address to repair cache regions to identify a matching repair cache region. Then, a local repair location router 603 compares a repair address portion of the memory address to a local repair location addresses particular to the matching repair cache region to identify a matching local repair address. If a matching local repair address is identified, a repair component 606 provides access to a repair data location according to the matching local repair address and the matching repair cache region. Otherwise, a main memory 604 provides access to a memory location according to the memory address. Other systems and methods are disclosed.

### FIELD OF THE INVENTION

The present invention relates generally to memory devices, and more particularly, to systems and methods for repairing/replacing faulty memory locations in memory devices.

### BACKGROUND OF THE INVENTION

Storage capacities of semiconductor memory devices continue to increase while dies on which the memory devices are fabricated continue to decrease. As a result, the number of memory cells present in memory devices and the complexity of the memory devices continues to increase as well. Additional memory cells and complexity require additional sense amplifiers, charge supply circuitry, addressing mechanisms, decoders, and the like. Further, the dimensions of components and/or structures present in memory devices necessarily shrink in response to the additional storage capacity. As a consequence, memory cells of memory devices can be more sensitive to defects, residues, and contaminants than memory cells of prior, smaller storage capacity memory devices. Such defects and contaminants can cause memory cells to be inoperable and unusable.

One technique to mitigate defects and contaminants and reduce the number of resulting defective cells is by tighter semiconductor fabrication process control and layout design/architecture. However, the ever-shrinking dimensions and increase in storage capacity can counteract the benefits of tighter process control and improvements in layout design/architecture. As a result, a significant number of memory devices are fabricated that include one or more defective memory cells. Without some type of correction mechanism, such memory devices can be unusable and/or introduce errors by their use.

One type of correction mechanism is to fabricate a number of redundant rows for memory devices. The number of redundant rows are formed in addition to original rows of memory cells. Then, during testing faulty memory cells and associated rows are identified. Subsequently, a selection device such as a fuse based device is employed to allow redundant rows to replace identified defective rows. As a result, addressing to memory cells in the original rows is rerouted to the replacement, redundant rows of memory cells. Thus, defective memory cells/rows are not apparent to external devices.

Another type of correction mechanism is to fabricate a number of redundant columns for memory devices in addition to original columns of memory cells. Defective or faulty memory cells/columns are then identified during testing. Subsequently, associated columns are replaced by one or more of the redundant columns by utilizing a selection mechanism such as a fuse based device. Accordingly, addressing to memory cells located in defective/faulty columns is rerouted to assigned redundant columns of memory cell. These defective memory cells/columns are not known to external devices.

One problem with the above correction mechanisms, redundant row replace and redundant column replace, is that large numbers of non-faulty cells can be needlessly replaced. For example, a single faulty memory cell, under a redundant row mechanism, requires that the row containing the single faulty memory cell be replaced. A single row in a memory device can have a large number of memory cells present, such as 512 or 1024 memory cells. Thus, one faulty memory cell can cause the other cells in the row, such as 511 or 1023, to be replaced. Such inefficiencies can reduce the storage capacity of memory devices by consuming valuable space on dies in order to provide for redundant rows and/or columns.

### SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present some concepts of the invention in a simplified form as a prelude to the more detailed description that is presented later.

The present invention facilitates scaling of memory devices and operation thereof. A relatively efficient repair cache system is employed to correct or repair identified faulty memory cells instead of row and/or column replace operations. The possible increased efficiency can allow for less repair memory cells to be employed than conventional mechanisms thereby saving die area.

The repair cache system stores a list of repair cache regions and lists of local repair location addresses associated with the repair cache regions. Additionally, the repair cache system maintains repair data locations that can be employed to repair/replace faulty memory cells present in main memory. The repair data locations are accessed by a matching repair cache region and a matching local repair location address during operation. Other systems and methods are disclosed.

To the accomplishment of the foregoing and related ends, the invention comprises the features hereinafter fully described and particularly pointed out in the claims. The following description and the annexed drawings set forth in detail certain illustrative aspects and implementations of the invention. These are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1A is a diagram illustrating random, isolated defects that can result from chemical mechanical planarization.

FIG. 1B is a diagram illustrating random, isolated defects that can result from via and contact voids during memory device fabrication.

FIG. 1C is a diagram that depicts formation of a blister in an exemplary semiconductor device.

FIG. 2A is a diagram illustrating a memory array of more recent non-volatile memory and random defects therein.

FIG. 2B is a diagram illustrating a non-volatile memory cell.

FIG. 3A is a diagram illustrating repair row correction mechanisms.

FIG. 3B is a diagram illustrating repair column correction mechanisms.

FIG. 3C is a diagram illustrating block repair correction mechanisms.

FIG. 4 is a diagram illustrating operation of a repair cache in accordance with an aspect of the present invention.

FIG. 5 is a diagram illustrating a portion of a memory array configured for a set associative repair cache in accordance with an aspect of the present invention.

FIG. 6 is a block diagram illustrating a repair cache system in accordance with an aspect of the present invention.

FIG. 7 is a block diagram illustrating an associative repair cache system in accordance with an aspect of the present invention.

FIG. 8 is a diagram illustrating an exemplary repair register bank in accordance with an aspect of the present invention.

FIG. 9 depicts repair data locations for a first repair cache region and a second repair region in accordance with an aspect of the present invention.

FIG. 10 is a flow diagram illustrating a method of operating a set associative repair cache in accordance with an aspect of the present invention.

FIG. 11 is a flow diagram illustrating a method of configuring a repair cache system in accordance with an aspect of the present invention.

### DETAILED DESCRIPTION OF THE INVENTION

The present invention will now be described with respect to the accompanying drawings in which like numbered elements represent like parts. The figures provided herewith and the accompanying description of the figures are merely provided for illustrative purposes. One of ordinary skill in the art should realize, based on the instant description, other implementations and methods for fabricating the devices and structures illustrated in the figures and in the following description.

The present invention facilitates scaling of memory devices and operation thereof by disclosing a repair cache employed for repairing or replacing identified faulty memory cells. The repair cache can attain increased efficiencies relative to convention row and/or column replacement correction mechanisms. The increased efficiency can mitigate the number of repair cells/locations employed thereby reducing die area consumption.

Redundant rows of memory, redundant columns of memory, and redundant blocks of memory are commonly employed to recover from faulty/defective memory cells. Faulty columns and/or rows that respectively contain one or more faulty memory cells are identified during testing. Then, the faulty columns and/or rows are “corrected” or replaced by an identical number of redundant rows and/or columns. If, for example, entire rows of memory cells are faulty, replacement of the rows by redundant rows is relatively efficient. However, if only a single memory cell within a row is faulty, replacement of the entire row by a redundant row is relatively inefficient.

Some fabrication induced, large area defects can impact large portions of rows, columns, or blocks. For such large area defects, row, column, and/or block replacement mechanisms can be relatively efficient and practical. However, other fabrication defects include random, isolated defects that affect a small, isolated number of memory cells (e.g., one). For these random isolated defects, row, column, and/or block replacement mechanisms are relatively inefficient.

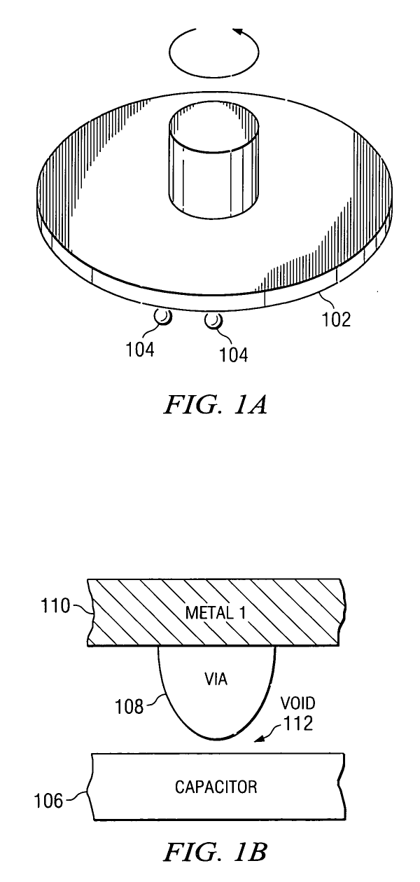

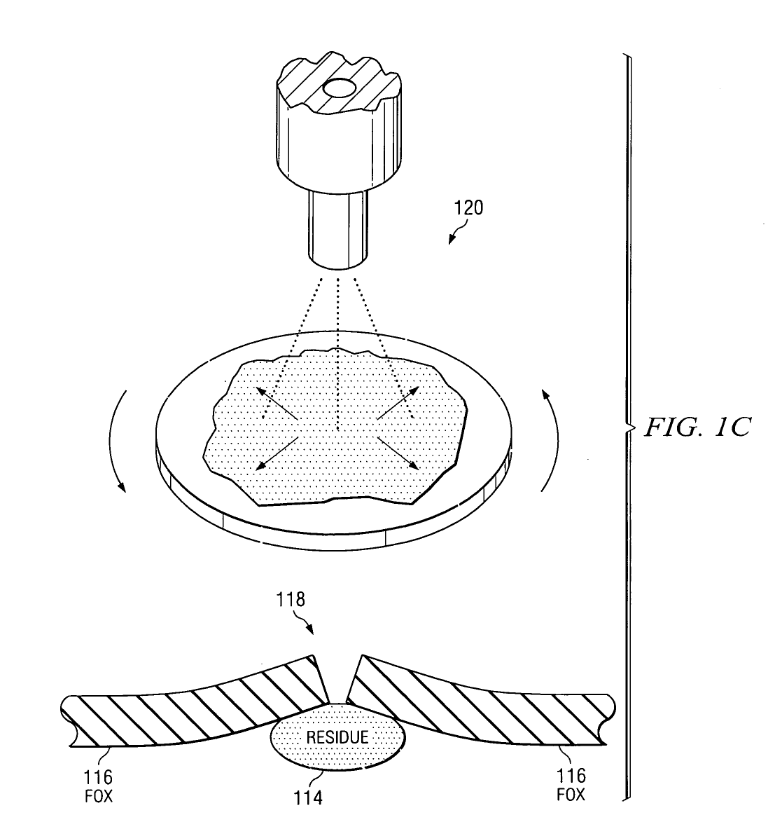

FIG. 1A is a diagram illustrating random, isolated defects that can result from chemical mechanical planarization (CMP). Some layers formed on semiconductor devices can require a flattening, polishing layer operation in order to promote uniformity and to permit additional layers to be formed thereon. This flattening and polishing operation is referred to as planarization. One common type of planarization is the CMP process, which employs a rotating head 102 positioned on a rotating wafer in an opposite direction. A slurry flows across the wafer surface as the head and wafer rotated. The slurry includes chemicals and particles that facilitate planarization of the wafer. However, the slurry and/or the CMP head can undesirably include residue 104 that causes isolated, random damage to the wafer and memory devices formed thereon. The residue 104 can, for example, abrasively contact metal layers resulting in scratches and/or missing metal, leading to unwanted open circuits and/or increased resistance. The random damage can result in random, isolated defects and, as a consequence, random, isolated, faulty memory cells.

FIG. 1B is a diagram illustrating random, isolated defects that can result from via and contact voids during memory device fabrication. Via formation and metallization are commonly performed during memory device fabrication in order to provide electrical connection to capacitors and other structures present within memory devices. However, vias or plugs can be defective in that they are not completely filled or that they were etched improperly thereby not properly connecting underlying structures. As an example, FIG. 1B shows a capacitor 106, a via 108, and a metal interconnect layer 110. In this example, the via 108 was not properly filled and, as a result, there is a void 112 present that breaks or prevents connection from the capacitor 106 to the via 108 and, therefore the metal interconnect layer 110. The void 112 can cause failure of a single memory cell by preventing access to the capacitor 106, but does not generally impact neighboring memory cells. As a result, the void 112 creates a random, isolated defect.

FIG. 1C is a diagram illustrating random, isolated defects that can result from etch or CMP residue during memory device fabrication. Etching processes are commonly performed during memory device fabrication, particularly with respect to capacitor formation and metallization. Etch residue from etch processes, such as plasma etching, can remain after completion of the etch process. Additionally, residue from planarization processes can also remain after completion. Subsequently formed layers cover the residue thereby trapping the residue. The formed layers become malformed or distorted as a result. Planarization processes, such as CMP, can damage the distorted layers by sheering off protruding crests, referred to as blisters.

FIG. 1C is a diagram that depicts formation of a blister in an exemplary semiconductor device. An etch process is performed that leaves undesired etch residue 114 on the device. A field oxide layer 116, in this example, is formed and distorted due to the presence of the residue 114. A metal layer deposition and planarization process 120 are then performed that results in formation of a blister 118 that breaks the field oxide layer 116. The blister 118 can lead to shorting and/or other problems and result in faulty memory cells.

The blisters, such as the blister 118, are a result of the undesired etch residue that remains after etching. The residue is typically randomly distributed. As a result, the blisters formed, and therefore the memory cells impacted, are also randomly distributed.

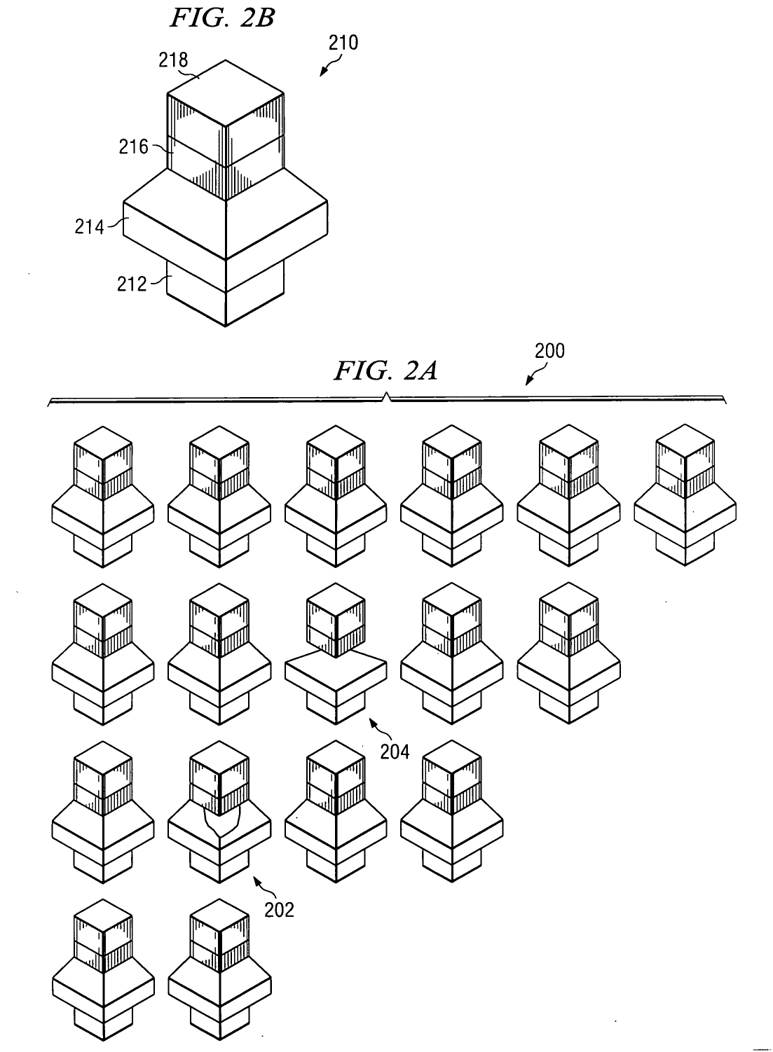

FIG. 2A is a diagram illustrating an exemplary memory array 200 of more recent non-volatile memory and random defects therein. The memory array 200 can be nonvolatile memories such as ferroelectric memory (FeRAM), Magnetoresistive Random Access Memory (MRAM), and Ovonic Unified Memory (OUM). These memories include new layers for memory elements that exist between a substrate and upper metal layers that therefore have a high probability of being damages by CMP or etch process residues that can result in random, isolated bit failures. The newer non-volatile memories contain electrodes and special films or layers for electric fields, magnetic fields, and/or simple resistance. Random defects to these electrode layers or special films or layers are potential sources for weak or faulty bits, which likely are isolated random defects not efficiently solved by replacing entire rows, columns, and/or blocks. These defects can result from CMP processes, etching and leaving residues, plasma etching and leaving residues, forming oxide layers and leaving residues, forming other layers and leaving residues, and the like and can introduce open circuits into the electrodes and/or special layers.

FeRAM utilize ferroelectric capacitors that possess two characteristics required for a nonvolatile memory cell, that is to have two stable states corresponding to the two binary levels in a digital memory, and to retain their states without electrical power.

MRAM is a method of storing data bits using magnetic charges instead of the electrical charges used by DRAM (dynamic random access memory). A metal is defined as magnetoresistive if it shows a slight change in electrical resistance when placed in a magnetic field. By combining the high speed of static RAM and the high density of DRAM, proponents say MRAM could be used to significantly improve electronic products by storing greater amounts of data, enabling it to be accessed faster while consuming less battery power than existing electronic memory.

OUM uses thin-film materials to store information economically and with excellent solid-state memory properties. The thin-film material is a phase-change chalcogenide alloy similar to the film used to store information on commercial CD-RW and DVD-RAM optical disks.

Optical memory disks use laser light to write small spots by converting the thin film back and forth from amorphous (disordered atomic structure) to crystalline (regular, highly repetitive, and ordered atomic structure). The digital data of 1s and 0s are stored as amorphous (high resistance and non-reflective) or crystalline (low resistance and reflective) structures. OUM devices store data in a similar manner but use electrical energy controlled by small transistors to electronically convert the material to crystalline or to amorphous (thus a 1 or a 0). This electronic solid-state memory stores data in a much smaller area and with higher speeds for both read and write than its optical counterpart.

The operating speed of OUM memory technology is similar to DRAM and many orders of magnitude faster than Flash write. Also, unlike conventional Flash memory, OUM memory is fully random accessible for memory addressing. Any given bit can be uniquely addressed and then written or read by the customer. Further, Flash memory “wears out” (fails) after 100,000 write cycles, while the OUM memory state can be written more than 10 trillion times, making this memory useful for program storage (Flash) as well as general purpose interactive (DRAM) data storage memory.

The memory array 200 of FIG. 2A is illustrated with two defective memory cells 202 and 204. Defects to special films present in the memory cells cause the cells 202 and 204 to improperly operate, thereby being defective or faulty.

FIG. 2B is a diagram illustrating a non-volatile memory cell 210. The memory cell 210 is of a more recent design such as FeRAM, OUM, and MRAM. The memory cell 210 includes a lower electrode 212, a special film 214, an upper electrode 216, and an extra via 218. The special film 214 has properties dependent on the type of memory (e.g., ferroelectric, magnetoresistive, phase-change ability) and can be sensitive to random defects. The special film 214, if damaged, only impacts the memory cell 210 and does not negatively impact other or surrounding memory cells. Similarly, damage to the lower electrode 212 and the upper electrode is limited to the memory cell 210.

The above figures and descriptions illustrate examples of some types of random defects that can occur in semiconductor device fabrication as appreciated by the inventor of the present invention that lead to random, isolated memory cell or bit failures. Some other types of random defects include oxide defects, blisters, missing metal/conductive material, CMP scratches, and CMP residue.

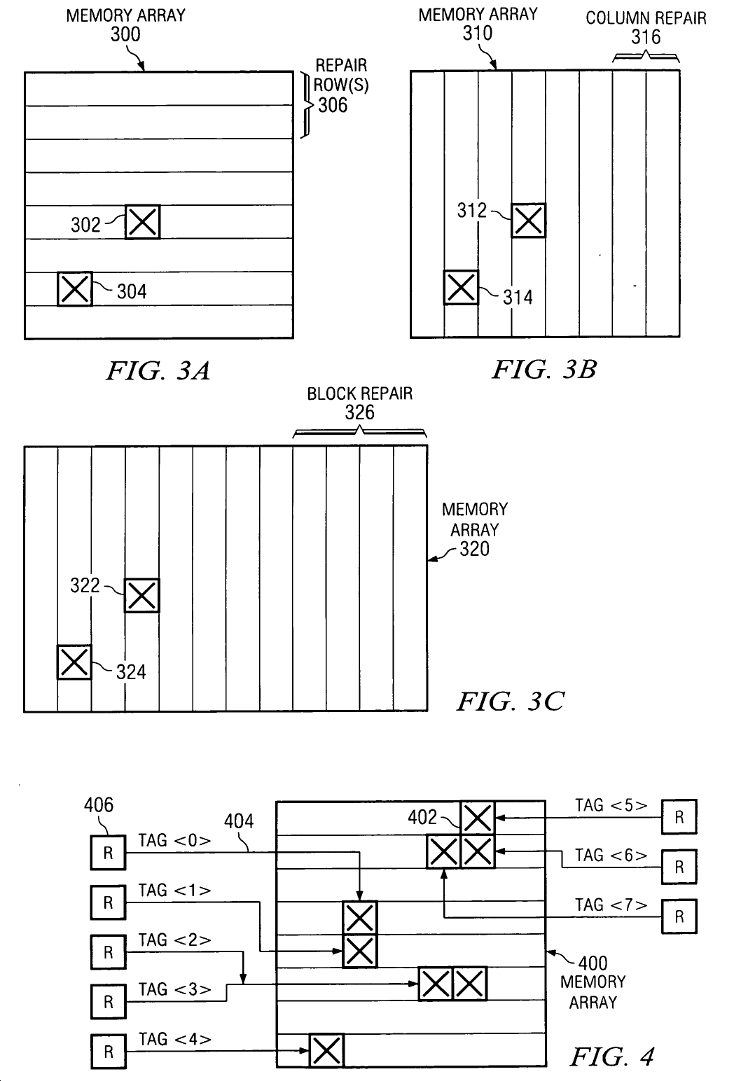

FIG. 3A is a diagram illustrating repair row correction mechanisms. A memory array 300 is shown comprised of a number of rows of memory cells/bits. Testing identifies first and second faulty memory cells 302 and 304 within the array 300. Redundant repair rows 306 are employed to replace the rows containing the faulty memory cells 302 and 304. A typical row in a memory device includes 1024 memory cells. Therefore, a single defective memory cell requires 1024 memory cells to be replaced. This type of replacement is relatively inefficient because other cells in the replaced rows were not necessarily defective.

FIG. 3B is a diagram illustrating repair column correction mechanisms. Here, a memory array 310 is comprised of a number of columns of memory cells/bits. Testing has identified first and second faulty memory cells 312 and 314 within the array 310. Under this correction mechanism, redundant repair columns 316 replace both columns comprising the first and second faulty memory cells 312 and 314. Typical columns are about 512 memory cells tall. Thus, in this example, replacement of a single faulty memory cell requires replacement of 512 memory cells (of which 511 are not defective). Again, this correction mechanism is relatively inefficient for isolated random defects because a large number of cells were replaced that operated correctly.

FIG. 3C is a diagram illustrating block repair correction mechanisms. A memory array 320 is comprised of blocks of memory cells. Respective blocks are comprised of a fixed number of rows and columns. In order to correct a defective memory cell, an entire block comprising the defective/faulty memory cell is replaced. Testing identified first and second faulty memory cells 302 and 304. In order to correct the identified faulty memory cells 302 and 304, two redundant blocks of memory cells 326 are employed. Once again, this correction mechanism is relatively inefficient as a large number of properly working memory cells are unnecessarily replaced.

FIG. 4 is a diagram illustrating operation of a repair cache in accordance with an aspect of the present invention. The repair cache is operative to repair/correct faulty memory cells including those that result from random, isolated defects in a relatively efficient manner.

FIG. 4 shows a memory array 400 comprised of a number of rows and columns. Due to random, isolated defects incurred during fabrication, such as those described supra, a number of faulty memory cells 402 are present. Typically, testing is performed that includes reading and writing to cells within the memory array 400, wherein cells that fail to properly store and maintain correct values are deemed faulty. A repair cache system of the present invention is operable to efficiently repair/correct the faulty memory cells 402.

Respective faulty memory locations 402 are replaced by repair data locations 406, also referred to as repair resources and/or repair locations, on a one for one basis. The repair data locations can store a varied number of bits such as, for example, 1 bit, 8 bits, 16 bits, 32 bits, and the like. It is noted that the repair data locations can be a single memory cell. The faulty memory locations can, likewise, respectively comprise a varied number of bits or a single memory cell. It is further noted that memory cells can be single bit memory cells or multi bit memory cells (e.g., 2 or more bits). Addresses to the faulty memory cells 402 are redirected towards the replacement data caches by address caches 404 that store pointers to the replacement data caches 406. As a result, only a single memory cell or small number of memory cells can be employed to correct a defective memory cell and is, therefore, typically more efficient than row replacement, column replacement, and/or block replacement mechanisms for random, isolated defects.

The repair cache of the present invention differs from typical, conventional memory caches. The repair cache of the present invention maintains a list of only identified faulty memory addresses and includes separate repair resources aside from a main memory or array. In contrast, a conventional memory cache only maintains a list of cached memory addresses and does not maintain separate resources for the cached addresses. Furthermore, the conventional memory cache stores data from a main memory whereas the repair cache of the present invention replaces data from a main memory.

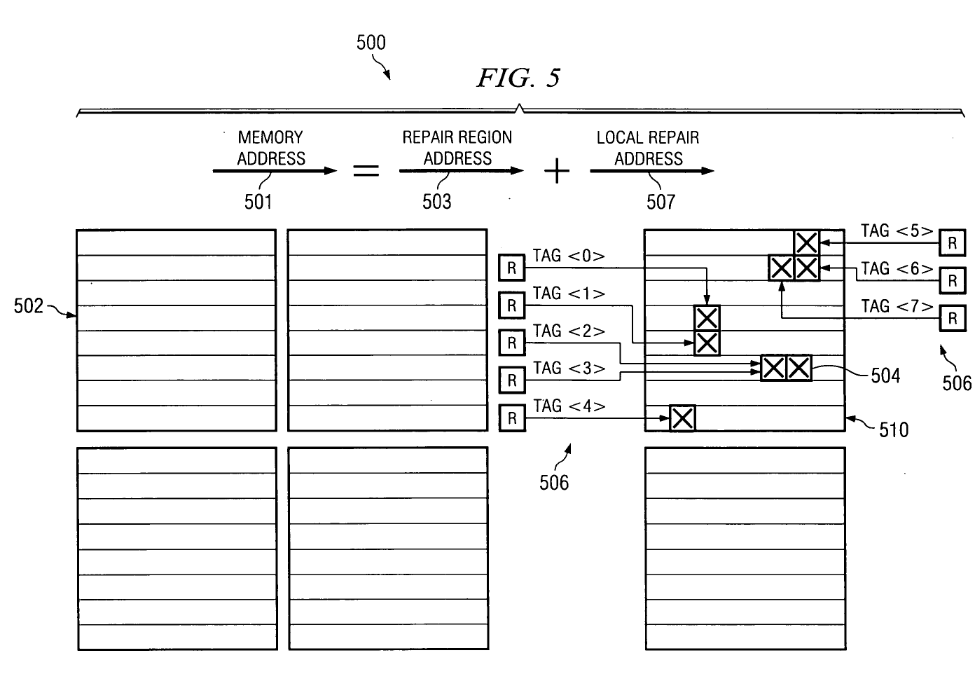

FIG. 5 is a diagram illustrating a portion of a memory array 500 configured for a set associative repair cache in accordance with an aspect of the present invention. The memory array 500 is provided for illustrative purposes and it is appreciated that the present invention contemplates other memory array(s) having alternate sizes and/or configurations.

The memory array 500 has a number of memory locations that are employed to store, maintain, and provide information content. The memory array 500 can be volatile or non-volatile memory and can be of a suitable memory type including, but not limited to, FeRAM, OUM, and MRAM. The memory locations typically store a word (e.g., 16-bits, 32-bits, 54-bits, and the like) of information content and are addressable by a memory address 501.

At some point, the memory locations are tested in order to identify faulty memory locations 504, which are memory locations that include one or more faulty memory cells. A number of suitable mechanisms can be employed to identify faulty memory cells and, therefore, faulty memory locations. One example of a suitable mechanism is to write selected patterns of data to memory cells, read patterns of data from the memory cells, and then compare the read patterns to the written patterns to identify faulty memory cells. Another example of a suitable mechanism is to repeatedly perform cycles of writing a first value to memory cells and then read back from the memory cells expecting the first value to be read back and then writing a second value to the memory cells and then reading back from the memory cells expecting the second value to be read back. Other suitable mechanisms of identifying faulty memory locations can be employed.

The memory locations of the array 500 are organized or configured into memory regions 502, which are associated with blocks or groups of memory locations. FIG. 5 depicts the memory regions 502 as blocks, however they can be organized in other configurations including, but not limited to, rows and columns. Repair cache regions 510 are memory regions 502 that are cached and are allocated repair locations. Typically, only some of the memory regions 502 have identified faulty memory locations. Therefore, only a subset of the memory regions are normally assigned as repair cache regions 510.

A portion of the memory address, referred to as a repair region address 503, is employed to identify memory regions of which memory locations are associated with. Accordingly, the repair region address 503 also identifies repair cache regions if the particular memory locations are present in repair cache regions. The repair cache regions 503 respectively include one or more local repair registers or repair locations 506 that can be employed to repair or correct identified faulty memory locations 504 within the respective repair region. A local repair address 507, which is also a portion of a memory location's memory address 501, is employed to access the local repair locations 506 within the repair cache regions.

During read/write operations for the memory array 500, requests for identified faulty memory locations are routed to a particular repair cache region according to the repair region address 503 and a particular local repair location or register within the particular repair region according to the local repair address 507.

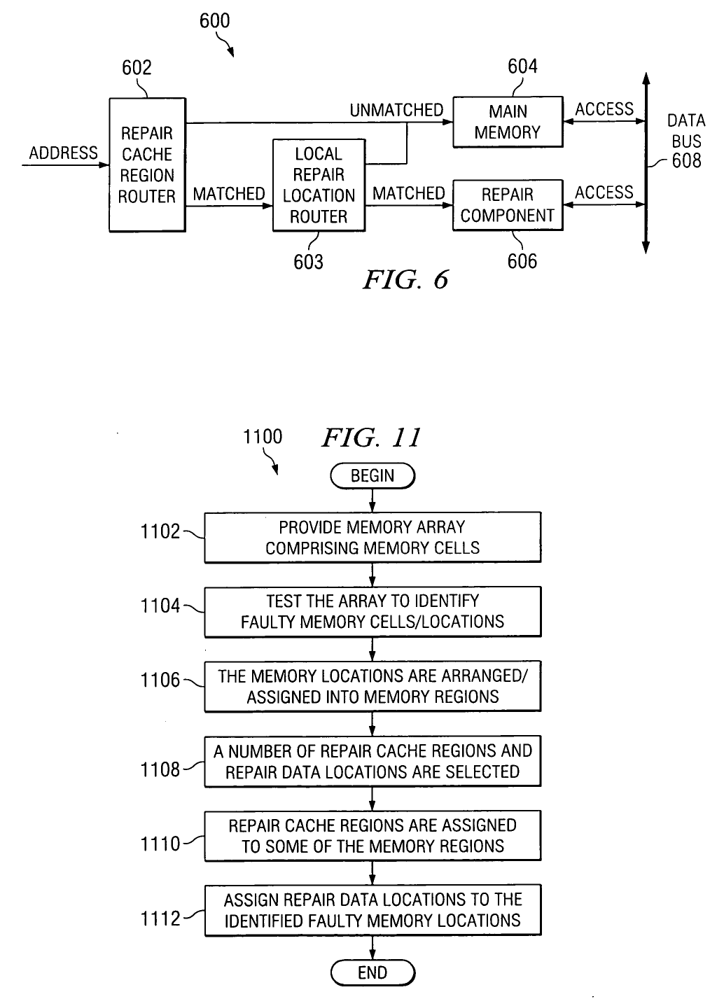

FIG. 6 is a block diagram illustrating a repair cache system 600 in accordance with an aspect of the present invention. The system 600 is operable to correct for faulty memory cells/locations by having redundant memory cells located in a repair component. The redundant memory cells/locations are accessed instead of the faulty memory cells within a main memory for read/write operations. By employing repair locations, faulty memory cells located within main memory can be accounted for while mitigating the number of redundant memory cells required to do so.

The repair cache system 600 includes a repair cache region router 602, a local repair location router 603, a main memory 604, a repair component 606, and a data bus 608. The system 600 routes memory operations to the main memory 604 or the repair component 606 by analyzing requests for matching repair cache regions and then by local repair locations.

The repair cache region router 602 receives memory addresses for read/write operations and routes the request to the main memory 604 or the local repair location router 603 according to a repair region portion of the memory addresses. The repair cache region router 602 can comprises tables, data structures, pointers, comparators, and other components that facilitate determining which component to route the request to. The local repair location router 603 receives matching region information from the repair cache region router 602 and routes the request to the main memory 604 or the repair component 606 according to a local region portion of the memory addresses. The local repair location router 603 can also comprises tables, data structures, pointers, comparators, and other components that facilitate determining which component to route the request to.

The main memory 604 comprises volatile and/or non-volatile memory locations, each of which can comprise one or more memory cells (e.g., a word of memory). The memory locations of the main memory 604 are identified as faulty or valid by a suitable testing mechanism, as described below. It is appreciated that suitable testing mechanisms can be employed and yet mistakenly identify valid memory locations.

The repair component 606 also comprises volatile and/or non-volatile memory locations, each of which can comprise one or more memory cells (e.g., a 32 bits). Both the main memory 604 and the repair component 606 can be comprised of a suitable memory type including, but not limited to, ferroelectric memory, magnetoresisteve random access memory, ovonic unified memory, dynamic random access memory, and the like.

Prior to performing operational read and/or write operations, the main memory 604 is tested and/or scanned to identify zero or more faulty memory locations within the main memory 604. The faulty memory locations include memory cell(s) of which at least one memory cell is determined or identified as faulty. A number of suitable mechanisms can be employed to identify faulty memory cells and, therefore, faulty memory locations. One example of a suitable mechanism is to write selected patterns of data to memory cells, read patterns of data from the memory cells, and then compare the read patterns to the written patterns to identify faulty memory cells. Another example of a suitable mechanism is to repeatedly perform cycles of writing a first value to memory cells and then read back from the memory cells expecting the first value to be read back and then writing a second value to the memory cells and then reading back from the memory cells expecting the second value to be read back. Other suitable mechanisms of identifying faulty memory locations can be employed.

Memory locations of the main memory 604 are arranged or configured into memory regions that typically have a fixed number of memory locations therein. After identifying the faulty memory locations, memory regions containing the faulty memory locations are designated as repair cache regions and the faulty memory locations are assigned repair data locations referenced within the repair cache regions by a local address portion of their memory addresses. The repair cache regions for the repair data locations, which replace the identified faulty memory locations, are referenced according to a repair region portion of the identified faulty memory locations' memory addresses. Then, during read/write memory operations, the repair data locations can then be employed instead of the faulty memory locations during device operation.

For read/write operations, the repair cache region router 602 receives a memory address and determines whether the memory address is within a valid repair cache region according to a repair region portion of the memory address. If a matching repair cache region is identified, the matching region is passed to the local repair location router 603, which determines whether the memory address has a valid repair data location according to a local address portion of the memory address. If the local repair location router 603 identifies a matching repair location address, the matching repair cache region and local address are passed to the repair component 606. The matching repair location or register is selected in the repair component 606 according to the repair cache region or the repair address (a portion of the memory address) and the local address (another portion of the memory address). The selected repair location is then coupled to the data bus 608 for read/write access in place of the faulty memory location located within the main memory.

If a matching repair cache region and/or a matching repair location are not identified, the memory address is provided to the main memory 604. A memory location of the main memory 604 referenced by the memory address is then coupled to the data bus 608 for read/write access.

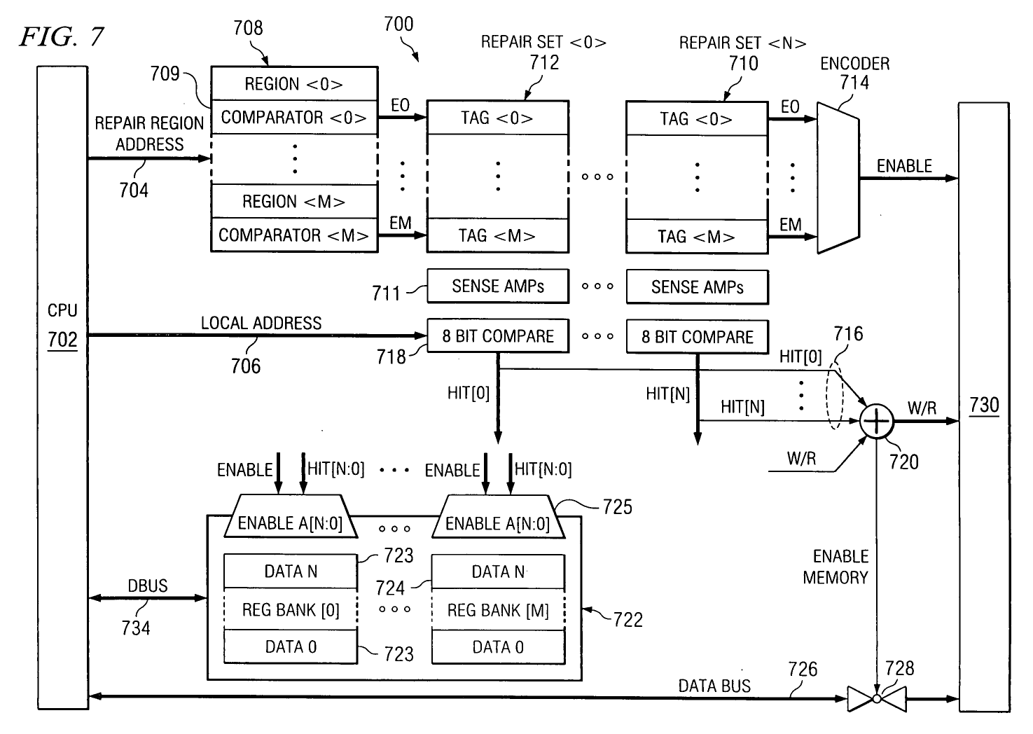

FIG. 7 is a block diagram illustrating an associative repair cache system 700 in accordance with an aspect of the present invention. The system 700 is operable to correct for faulty memory cells by having redundant memory cells located in repair data locations, which are accessed instead of the faulty memory cells for read/write operations. By employing repair regions and repair data locations within regions, storage requirements for addressing repair data locations and contents thereof can be reduced compared with conventional row, column, and/or block repair mechanisms. Furthermore, the reduced storage requirements mitigate die area employed for repairing/correcting faulty memory cells.

The system 700 includes a central processor unit 702, a repair region register bank 708, repair region comparators 709, repair sets 710, local address comparators 718, a repair data bank 722, a main memory 730, and a data bus 726.

The central processor unit 702 is operable to access memory locations of the main memory 730 by memory addresses in order to read to and write from addressed memory locations. It is appreciated that the central processor unit 702 performs other processor related functions and can be one of a number of processors present in an electronic device. The central processor unit 702, as well as some or all of the system 700, can be part of an electronic device such as, but not limited to, a personal computer, a personal digital assistant, a mobile/cellular telephone, a laptop computer, a notebook computer, a digital camera, and the like.

Memory locations of the main memory 730 are arranged and/or configured into memory regions of a fixed size. Generally, a subset of the memory regions are allocated repair cache locations for repairing/replacing identified faulty memory locations. The subset of memory regions are referred to as repair cache regions. As an example, a main memory comprising 1024 memory regions having 256 memory locations may have only 48 repair cache regions associated with 48 of the memory regions. A further description of this relationship is provided infra. The memory locations of the main memory 730 are addressed by memory addresses. Both the memory regions and repair cache regions are indicated or referenced by a portion of the memory addresses referred to as a repair region address 704. Repair data locations 723, which are associated with particular repair cache regions, are indicated or referenced by another portion of the memory address referred to as a local address 706.

The repair region register bank 708 comprises a list of repair cache regions. Generally, the repair register bank 708 is comprised of volatile or non-volatile memory that stores repair cache region addresses as entries. The repair region comparators 709 are respectively associated with individual repair cache regions and receive the repair region address and compare the received repair region address with the list of repair cache regions from the repair register bank 708 to identify a matching repair cache region. Additionally, the matching comparator, if a matching region is identified, generates an enable signal that indicates the matching repair cache region.

The repair sets 710 maintain M local repair location addresses or pointers 712; also referred to as TAGs and have a single local repair location address per repair cache region, as entries where M is the number of repair cache regions in the system 700. The number of repair sets 710 present, N, is related to the number of local repair addresses selected per repair cache region. Thus, if there are eight local repair addresses per region, N is equal to eight and there are eight repair sets. The local repair locations addresses 712 include an address that is a local address for repair data locations within particular repair cache regions. The local repair location addresses 712 can optionally also include a repair enable indicator (not shown), which can be a single bit indicating whether to local repair location address is a valid repair or not. In operation, the repair sets 710 each provide a selected local repair location address according to the enable signals 708 for the repair region 704.

The repair sets 710 receive the enable signal from the repair region comparators 709 on a matching repair cache region being identified. The enable signal selects repair locations addresses or pointers for the matching repair cache region. The local address comparators 718 compare the selected local repair location addresses with the local address 706 to identify a matching local repair location address. The matching local comparator, on identifying the matching local repair location address, generates a local match or HIT signal 716 that indicates the matching local repair location address. Sense amps 711 can optionally be present and employed to provide the selected local repair location addresses to the local comparators 718.

The repair data bank 722 includes a plurality of repair register banks 724 and a plurality of data bank decoders 725. Typically, there is one repair register bank per repair cache region and one data bank decoder per repair register bank. The repair register banks respectively comprise repair data locations or registers 723 associated with one particular repair cache region.

The repair register banks 724 are selected via the data bank decoders 725 according to a selected repair cache region, which is identified from the enable signal generated by the encoder 714. It is appreciated that alternate aspects of the invention can select a repair register bank according to other mechanisms that select according to the repair region address, which corresponds to a repair cache region. Repair data locations 723 are selected from individual repair register banks according to the local match signal 716, which causes one repair data location to be selected per repair register bank 704. It is appreciated that alternate aspects of the invention can select repair data locations according to other mechanisms that select according to the local address 706.

The repair register banks 724 can be comprised of non-volatile or volatile memory. When comprised of volatile memory, the repair data locations 723 can be maintained external to the system 700 and then loaded or written into the assigned repair register banks upon initialization or startup of the system 700.

A data bus 726 is present and allows information content/data, including memory addresses, write data, read data, to be transferred to and from the CPU 702 and the main memory 730. A repair mode circuit 720 controls access to the the main memory 730 by way of a data bus switch 728, which connects and disconnects the main memory 730 to and from the data bus 726. If a matching repair cache region and a matching local repair address are found, access to the data bus 726 by the main memory 730 is disabled. Otherwise, access to the data bus 726 by the main memory 730 is enabled.

FIG. 7 is illustrated with examples of specific bit lengths and regions in order to facilitate a better understanding of the present invention. It is appreciated that present invention is contemplated as being employed for any suitable bit sizes, memory address size, number of repair regions, and the like. Additionally, other components can be present in the system such as, sense amps and decoders. Decoders and sense amplifiers can be shared by the repair data bank 722 and the main memory 730.

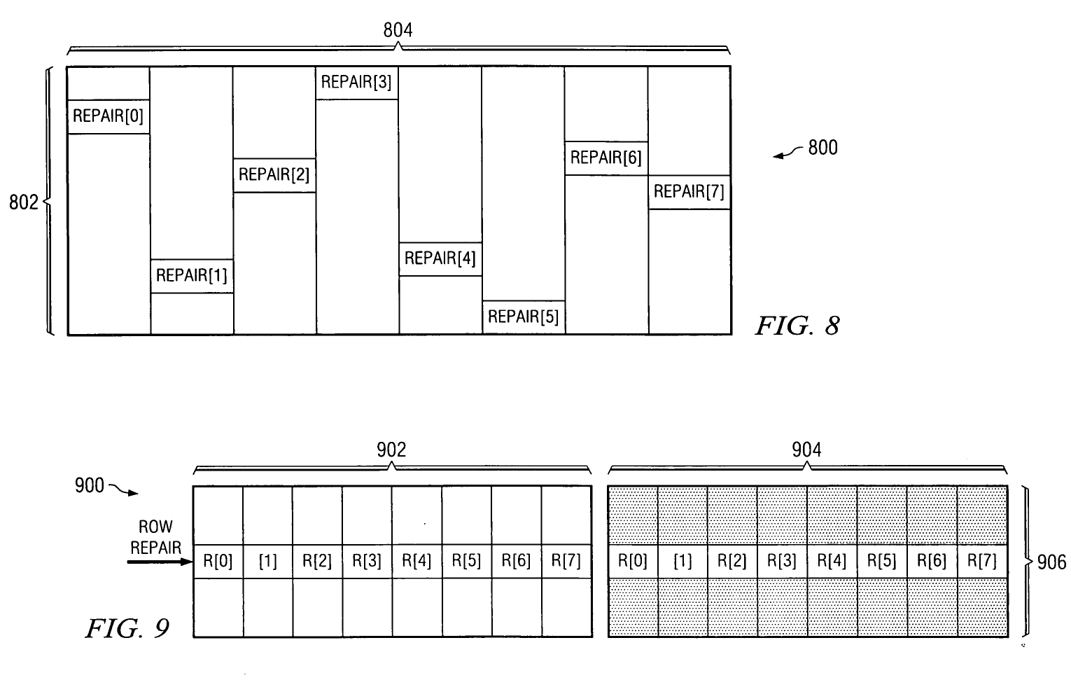

FIG. 8 is a diagram illustrating an exemplary repair register bank 800 in accordance with an aspect of the present invention. In this example, the repair register bank 800 is present in a memory array/device having 1024 memory regions. A subset of these regions are cached, which means that they have assigned repair data locations associated with identified faulty memory cells, and are referred to as repair cache regions. In this example, out of 1024 memory regions, 48 are arranged or configured as repair cache regions. Both the memory regions and the repair cache regions can be identified according to a selected portion of memory addresses for memory locations of the memory device. These selected portions are referred to as repair region addresses and repair cache region addresses.

Accordingly, a repair cache region address, also a repair region address, corresponds to a particular repair cache region and memory region of the memory device. As an example, of 1024 possible memory regions, 48 regions can be selected as repair cache regions for repair/correction during testing of the memory device in the present example. As stated previously, a repair address and local address are derived from individual memory addresses. As a result, the size of the repair address and the local address are related to the size of the memory address. As an example, for memory addresses that are 18-bits in length, an exemplary repair region address size of 8-bits can be selected and employed to configure and/or arrange memory regions and repair cache regions. Further, an exemplary local address size of 10-bits can be selected and employed to assign local repair data locations to identified faulty memory locations.

The repair register bank 800 is depicted in FIG. 8 as comprising eight local repair data locations 804 that can be employed to repair/replaced identified faulty memory locations. The repair data locations 804 have a storage size 802, typically a word (e.g., 16-bits, 32-bits, and the like) that generally corresponds to a storage size for the memory locations of the memory device. The repair register bank 800 is associated with a particular repair cache region identifiable via the repair address portion. The individual local repair data locations 804 are associated with memory locations and identifiable via the local address portion.

The organization/configuration of the repair region 800 is exemplary and it is appreciated the present invention contemplates other configurations. For example, repair register banks can be employed with a greater or lesser number of repair data locations.

As described above, the present invention allows replacing of bits or small numbers of bits/cells without replacing entire rows and/or columns. However, in some circumstances it can be advantageous to replace entire rows and/or columns. The present invention can be adapted to replace entire rows and/or columns. In order to do so, multiple regions can be linked in order to form a complete row and/or column repair.

FIG. 9 is a diagram illustrating an exemplary row repair in accordance with an aspect of the present invention. A single row of a memory array comprises 512 bits. In the example of FIG. 9, 48 repair cache regions are present and respectively include eight 32 bit repair addresses. As a result, each repair region can replace 256 (consecutive) bits.

FIG. 9 depicts repair data locations for a first repair cache region 902 and a second repair region 904 in accordance with an aspect of the present invention. Combined, the regions 902 and 904 are operable to replace/correct 512 bitsc which is also the number of bits in a row of the memory array. Accordingly, the first repair region 902 and the second repair region 904 can both be employed to replace 512 bits of a faulty/defective row as a single replacement row 906. In the present example, 48 repair regions with eight 32 bit word repairs permit a total of 24 complete row repairs for the memory array. It is appreciated that the present invention includes other common row lengths, such as 1024 bits, differing numbers of repair regions, differing numbers of repair addresses/locations, and differing numbers of bit sizes for the repair addresses.

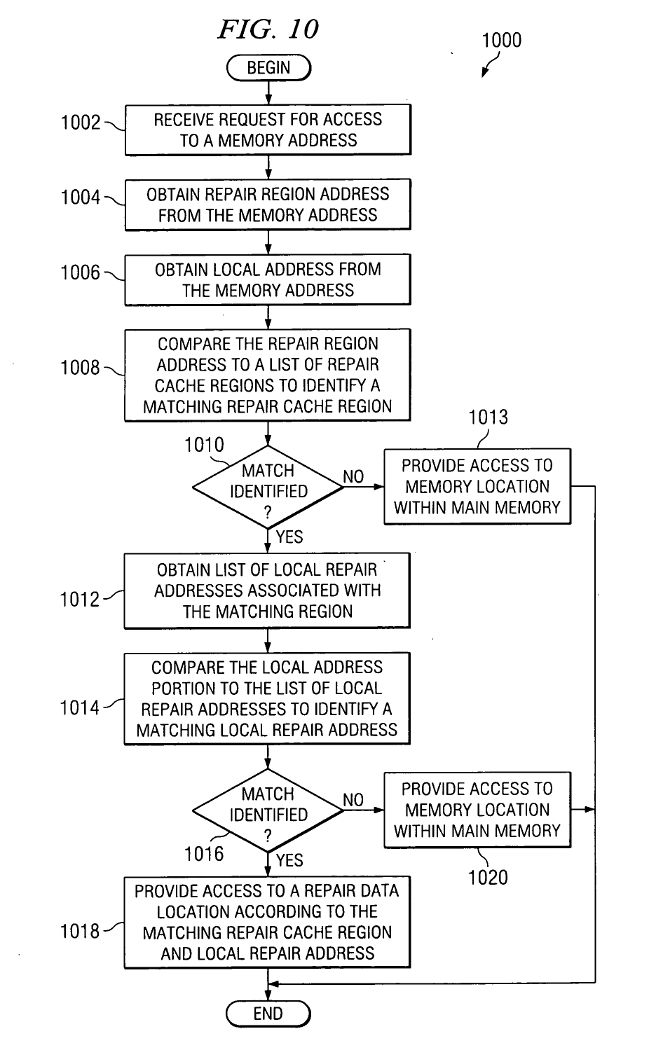

In view of the foregoing structural and functional features described above, methodologies in accordance with various aspects of the present invention will be better appreciated with reference to the above figures. While, for purposes of simplicity of explanation, the methodologies of FIGS. 10 and 11 are depicted and described as executing serially, it is to be understood and appreciated that the present invention is not limited by the illustrated order, as some aspects could, in accordance with the present invention, occur in different orders and/or concurrently with other aspects from that depicted and described herein. Moreover, not all illustrated features may be required to implement a methodology in accordance with an aspect the present invention.

FIG. 10 is a flow diagram illustrating a method 1000 of operating a set associative repair cache in accordance with an aspect of the present invention. The method re-routes requests for identified faulty memory locations of a memory device/array to repair data locations or registers within a repair component (e.g., repair data banks).

The method 1000 begins at block 1002, wherein a request for access to a memory location having a memory address is received. The request includes read and/or write access to the memory address. Typically, a requester has no knowledge as to whether the memory location in the memory device addressed by the memory address is faulty or not.

A repair region address of the memory address is obtained at block 1004. The repair region portion typically comprises a specific number of consecutive bits of the memory address (e.g., the upper 10 bits). The repair region address corresponds to and/or identifies a memory region of the memory device.

A local address of the memory address is obtained at block 1006. The local address portion also typically comprises a specific number of consecutive bits of the memory address (e.g., the lower 10 bits). The local address portion corresponds to and/or identifies the memory location with reference to the memory region in which it is located.

The repair region address is compared to a list of repair cache regions to identify a matching repair cache region at block 1008. The repair cache regions are also identified via an address that is equal to the size (e.g., 10-bits) of the repair cache addresses. The list of repair cache regions is a number of regions associated with a subset of memory regions of the memory device that have one or more faulty locations associated therewith. Typically, there are less repair cache regions than memory regions.

The number of repair cache regions present can vary depending upon a number of factors and can be established during testing of the memory device. For example, a larger number of errors can suggest more regions present within the list of repair cache regions. Other factors include array density, randomness, and the like.

The number of bits employed to identify the repair cache regions and the memory regions is also implementation dependent. The more bits employed to represent/identify the repair cache regions, the smaller the regions are. Conversely, less bits employed to represent/identify the repair cache regions results in larger repair cache regions. Factors that affect the number of bits employed include error rate, randomness of errors, array density, operating speed, and the like.

If a matching repair cache region is identified at block 1010, a list of local repair cache addresses that are associated with the matching repair cache region is provided at block 1012. Otherwise, the memory location within the main memory is selected according to the memory address and data access is provided to the memory location at block 1013 and the method 1000 ends. The list of local repair addresses is a list of pointers to repair data locations which are employed to replace/correct identified faulty memory cells/bits of the device. Continuing, the local address portion of the memory address is compared with the list of local repair addresses to identify a matching local repair address at block 1014.

The number of bits employed for the local repair addresses and the local address (e.g., 10 bits) is also implementation dependent. The more bits employed to represent/identify the repair cache addresses, the more data locations present per repair cache region. Conversely, less bits employed to represent/identify the local repair addresses results less data locations present per repair cache region. Factors that affect the number of bits employed include error rate, randomness of errors, array density, operating speed, and the like.

If the matching repair address is identified at 1016, data access is provided to a data location according to the matching repair region and the matching local repair address at block 1018. The data location stores a number of bits that depends on implementation such as, for example, 10 bits, 16 bits, 32 bits, 1 bit, and the like. Otherwise, the memory location within the main memory is selected according to the memory address and data access is provided to the memory location at block 1020 and the method 1000 ends.

FIG. 11 is a flow diagram illustrating a method 1100 of configuring a repair cache system in accordance with an aspect of the present invention. The method 1100 is operable to test and identify faulty memory bits/cells and/or locations located within a memory array and configure the repair cache system so that repair data locations are employed in place of identified faulty memory cells.

The method 1100 begins at block 1102 wherein a memory array comprising a number of memory cells and locations is provided. The memory cells can be single bit memory cells and/or multi bit memory cells.

The memory cells of the array are tested in order to identify faulty memory locations at block 1104. The faulty memory locations are comprised of and store a selected number of bits such as, for example, 1 bit, 8 bits, 16 bits, 32 bits, 64 bits, and the like, wherein at least one memory cell for the memory locations is faulty.

The memory locations of the device are arranged into memory regions at block 1106. The memory regions are of a fixed size and can be sized and arranged according to factors such as, but not limited to, location of identified faulty memory locations, error rate, device size, and the like.

A number/amount of repair cache regions and a number/amount of repair data locations are selected according to repair factors such as, the identified faulty memory locations at block 1108. Other factors that can be considered include the number of bits employed, error rate, randomness of errors, array density, operating speed, and the like. In alternate aspects of the invention, the number of repair cache regions, memory regions and the repair data locations are predetermined. The number of repair cache regions is less than the number of memory regions.

Repair cache regions are selectively assigned to memory regions of the device that include identified faulty memory locations at block 1110. As a result, the identified faulty memory locations are assigned to particular repair cache regions. It is noted that the repair cache regions are associated with the same memory locations as the associated memory regions. The repair cache regions can be identified with a repair address portion of memory addresses for memory locations within the memory region (e.g., upper 10-bits).

Continuing with the method 1100, the identified faulty memory locations are assigned local repair cache addresses and associated repair data locations at block 1112. The local repair cache addresses can simply be a local address portion (e.g., lower 8-bits) of the identified faulty memory locations assigned there to.

Although the invention has been shown and described with respect to a certain aspect or various aspects, it is obvious that equivalent alterations and modifications will occur to others skilled in the art upon the reading and understanding of this specification and the annexed drawings. In particular regard to the various functions performed by the above described components (assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several aspects of the invention, such feature may be combined with one or more other features of the other aspects as may be desired and advantageous for any given or particular application. Furthermore, to the extent that the term “includes” is used in either the detailed description or the claims, such term is intended to be inclusive in a manner similar to the term “comprising.”

What is claimed is:

1. A repair cache system comprising:
a repair region register bank that maintains a list of repair cache regions;
repair region comparators coupled to the repair region register bank that receive a repair region address of a memory address, compare the repair region address to the list of repair cache regions to identify a matching repair cache region;
repair sets that maintain local repair location addresses provide local repair locations addresses selected according to the matching repair cache region;
local comparators coupled to the repair sets that compare the local repair location addresses to a local address of the memory address to identify a matching local repair location address; and
a repair data bank that maintains a plurality of repair data locations, and provides read/write access to a repair data location of the plurality of repair data locations according to the matching repair cache region and the matching local repair location address.

2. The system of claim 1, further comprising:
a main memory;
a central processor unit,
a data bus connected to the central processor unit;
a repair mode circuit that controllably connects the central processor unit to the data bus on failure of the repair region comparators to identify the matching repair cache region and the local comparators to identify the matching local repair location address.

3. The system of claim 1, wherein a repair region comparator that identifies the matching repair cache region generates an enable signal that identifies the matching repair cache region.

4. The system of claim 1, wherein the repair data locations respectively comprise a single bit.

5. The system of claim 1, wherein the repair data locations comprise 32 bits.

6. The system of claim 1, wherein the repair cache regions are represented with 10 bits.

7. The system of claim 1, further comprising a main memory, wherein the memory address references an identified valid memory location.

8. The system of claim 1, further comprising a main memory, wherein the memory address references an identified faulty memory location.

9. The system of claim 1, wherein the repair data bank comprises a number of data banks addressable by the matching repair cache region, wherein the data banks respectively comprise portions of the plurality of repair data locations and are addressable by the matching local repair location address.

10. A repair cache system comprising:
a repair cache region router that receives a request for access to a memory location having a memory address, that maintains a list or repair cache regions, and routes the request to a memory component on failure to identify a matching repair cache region and to a local repair location router according to a repair address portion of the memory address on identifying a matching repair cache region;
the local repair location router that maintains a list of local repair location addresses and selectively routes the request to the main memory on failure to identify a matching repair location address or to a repair component according to a local address portion of the memory address on identifying a matching local repair location address;
the main memory that provides access to a memory location addressed by the memory address in response to the request; and
the repair component that provides access to a repair data location addressed by the matching repair cache region and the matching local repair location address.

11. The system of claim 10, wherein the repair cache region router further comprises repair region comparators that compare the list of repair cache regions to the repair address to identify the matching repair cache region.

12. The system of claim 10, wherein the local repair location router further comprises local comparators that compare a subset of the list of local repair location addresses selected according to the matching repair cache region to the local address to identify the matching local repair location address.

13. A method of operating a repair cache comprising:
receiving a request for access to a memory address;
comparing a repair region portion of the memory address to a list of repair cache regions to identify a matching repair cache region;
providing a list of local repair location addresses associated with the matching repair cache region;
comparing a local address portion of the memory address to the list of local repair location addresses to identify a matching local address; and
on the matching repair cache region and the matching local address being identified, providing access to a repair data location according to the matching repair cache region and the matching repair address.

14. The method of claim 13, further comprising providing read/write access to a memory location within a main memory according to the memory address on the matching repair cache region being unidentified.

15. The method of claim 13, wherein providing access to the repair data location comprises writing content to the repair data location.

16. The method of claim 13, further comprising generating the request for access by a central processor unit, wherein providing access to the repair data location further comprises providing access to the repair data location to the central processor unit.

17. The method of claim 13, wherein providing access to the repair data location comprises reading content from the repair data location.

18. A method of configuring a set associative repair cache system comprising:
providing a memory array comprising one or more memory cells;
testing memory cells of the array to identify faulty memory cells and faulty memory locations;
arranging memory locations of the array into memory regions;
selecting a number of repair cache regions and repair data locations according to repair factors;
selectively assigning repair cache regions to memory regions having one or more identified faulty memory locations;
selectively assigning repair data locations, arranged according to the assigned repair cache regions, to the identified faulty memory locations.

19. The method of claim 17, wherein the repair factors include number of faulty memory cells, randomness of faulty memory cells, and size of the memory array.

20. The method of claim 17, wherein providing the memory array comprises fabricating the memory array and introducing random, isolated defects that cause the one or more faulty memory cells.

21. The method of claim 17, wherein arranging the memory locations of the array into memory regions is performed according to the identified faulty memory locations.
